(19) United States
(12) Patent Application Publication
(10) Pub. No.: US 2026/0034685 A1
(43) Pub. Date: Feb. 5, 2026

(54) GRIPPER AND ROBOT APPARATUS INCLUDING GRIPPER THEREOF

(71) Applicant: SAMSUNG ELECTRONICS CO., LTD., Suwon-si (KR)

(72) Inventors: Cheoggyu HWANG, Suwon-si (KR); Sungman PARK, Suwon-si (KR); Jinho CHOI, Suwon-si (KR); Heeseung CHOI, Suwon-si (KR); Baeseok LIM, Suwon-si (KR)

(73) Assignee: SAMSUNG ELECTRONICS CO., LTD., Suwon-si (KR)

(21) Appl. No.: 19/271,228

(22) Filed: Jul. 16, 2025

Related U.S. Application Data
(63) Continuation of application No. PCT/KR2025/006308, filed on May 9, 2025.

(30) Foreign Application Priority Data
Aug. 5, 2024 (KR) 10-2024-0104116
Jan. 31, 2025 (KR) 10-2025-0012643

(51) Int. Cl. B25J 15/02; B25J 15/04; B25J 15/06; B25J 19/00

(52) U.S. Cl. CPC B25J 15/0293; B25J 15/0475; B25J 15/0616; B25J 19/0091

(57) ABSTRACT

A gripper includes a palm module configured such that finger modules of different forms are detachably couplable to the palm module, a plurality of finger modules detachably coupled to the palm module, a linear actuator configured to adjust a distance between the plurality of finger modules that are detachably coupled to the palm module, and a plurality of rotation actuators between the linear actuator and the plurality of finger modules, the plurality of rotation actuators configured to respectively rotate the plurality of finger modules about respective first rotation axes extending in a first direction from the palm module toward the plurality of rotation actuators.

### CROSS-REFERENCE TO RELATED APPLICATIONS

This application is a continuation application of International Application No. PCT/KR2025/006308 designating the United States, filed on May 9, 2025, in the Korean Intellectual Property Receiving Office, and which is based on and claims priority to Korean Patent Application No. 10-2024-0104116, filed on Aug. 5, 2024, in the Korean Intellectual Property Office, and Korean Patent Application No. 10-2025-0012643, filed on Jan. 31, 2025 in the Korean Intellectual Property Office, the disclosures of which are incorporated by reference herein in their entireties.

### BACKGROUND

### 1. Field

The disclosure relates to a gripper and a robot apparatus including the gripper.

### 2. Description of the Related Art

With developments in technology, robot technology is being utilized to substitute human labor in various fields. Specifically, robot apparatuses are being developed in fields that require detailed and sophisticated work such as factories, construction, medical sites, and the field of aerospace.

In order for the robot apparatus to perform detailed and sophisticated work, use of a gripper is essential.

However, because grippers of the related art use a finger module of a single shape that is not replaceable, there has been a problem of being able to perform only one operation or limited numbers of operations.

### SUMMARY

Provided are a gripper and a robot apparatus including the gripper.

Additional aspects will be set forth in part in the description which follows and, in part, will be apparent from the description, or may be learned by practice of the presented embodiments.

According to an aspect of the disclosure, a gripper may include a palm module configured such that finger modules of different forms are detachably couplable to the palm module, a plurality of finger modules detachably coupled to the palm module, a linear actuator configured to adjust a distance between the plurality of finger modules that are detachably coupled to the palm module, and a plurality of rotation actuators between the linear actuator and the plurality of finger modules, the plurality of rotation actuators configured to respectively rotate the plurality of finger modules about respective first rotation axes extending in a first direction from the palm module toward the plurality of rotation actuators.

At least one finger module of the plurality of finger modules may include a roll module that is rotatable about a second axis extending in a second direction that is perpendicular to a respective first rotation axis, and at least one finger extending from the roll module.

The roll module may include a first roller and a second roller on opposite ends of the roll module in the second direction, and that are independently rotatable, and the first roller may be rotatable in a direction that is opposite to a direction in which the second roller is rotatable.

Each finger module of the plurality of finger modules may include a finger detachably couplable to a respective rotation actuator of the plurality of rotation actuators, and a plurality of fingertips at an end portion of the finger.

Each fingertip of the plurality of fingertips may include a plurality of tips of different types from one another which are across each other based on a point where a respective fingertip is coupled to a respective finger module of the plurality of finger modules, and each finger module of the plurality of finger modules may include a rotation tip module configured to rotate a respective fingertip to cause a tip corresponding to a characteristic of a target to face the target.

The plurality of tips may include a first tip having a first contact surface configured to contact the target, and a second tip having a second contact surface configured to contact the target, and a width of the second contact surface may be greater than a width of the first contact surface.

The plurality of fingertips may include suction tips configured to grasp a target.

The gripper may include a memory, a communicator, and a processor configured to store, based on at least one finger module of the plurality of finger modules being coupled to the palm module, first module information of the at least one finger module in the memory based on receiving the first module information through the communicator, and control at least one rotation actuator of the plurality of rotation actuators to which the at least one finger module is coupled and the linear actuator to perform an operation corresponding to the first module information.

The processor may be further configured to store, based on a first finger module that is coupled to the palm module being substituted with a second finger module, second module information of the second finger module in the memory based on receiving the second module information through the communicator, and control the linear actuator and the at least one rotation actuator to perform an operation corresponding to the second module information of the substituted finger module.

Each finger module of the plurality of finger modules may include dual pinchers coupled to a respective rotation actuator of the plurality of rotation actuators and configured to grasp a target.

Each finger module of the plurality of finger modules may include an elastic element at an outer surface of the figure module configured to prevent damage to a target in a process of grasping the target.

According to an aspect of an example embodiment, a robot apparatus may include a main body, and a gripper coupled to the main body, where the gripper may include a palm module configured such that finger modules of different forms are detachably couplable to the palm module, a plurality of finger modules detachably coupled to the palm module, a linear actuator configured to adjust a distance between the plurality of finger modules that are detachably coupled to the palm module, and a plurality of rotation actuators between the linear actuator and the plurality of finger modules, of the plurality of rotation actuators configured to respectively rotate the plurality of finger modules about respective first rotation axes extending in a first direction from the palm module toward the plurality of rotation actuators.

At least one finger module of the plurality of finger modules may include a roll module that is rotatable about a second axis extending in a second direction that is perpendicular to a respective first rotation axis, and at least one finger extending from the roll module.

The roll module may include a first roller and second roller on opposite ends of the roll module in the second direction, and that are independently rotatable, and the first roller may be rotatable in a direction that is opposite to a direction in which the second roller is rotatable.

Each finger module of the plurality of finger modules may include a finger detachably couplable to a respective rotation actuator of the plurality of rotation actuators, and a plurality of fingertips at an end portion of the finger.

Each fingertip of the plurality of fingertips may include a plurality of tips of different types from one another which are across each other based on a point where a respective fingertip is coupled to a respective finger module of the plurality of finger modules, and each finger module of the plurality of finger modules may include a rotation tip module configured to rotate a respective fingertip to cause a tip corresponding to a characteristic of a target to face the target.

The plurality of tips may include a first tip having a first contact surface configured to contact the target and a second tip having a second contact surface configured to contact the target, and a width of the second contact surface may be greater than a width of the first contact surface.

The robot apparatus may include a memory, a communicator, and a processor configured to store, based on at least one finger module of the plurality of finger modules being coupled to the palm module, first module information of the at least one finger module in the memory based on receiving the first module information through the communicator, and control at least one rotation actuator of the plurality of rotation actuators to which the at least one finger module is coupled and the linear actuator to perform an operation corresponding to the first module information.

The processor may be further configured to store, based on a first finger module that is coupled to the palm module being substituted with a second finger module, second module information of the second finger module in the memory based on receiving the second module information through the communicator, and control the linear actuator and the at least one rotation actuator to perform an operation corresponding to the second module information of the substituted finger module.

According to an aspect of the disclosure, a gripper may include a processor, a palm module configured such that finger modules of different forms are detachably couplable to the palm module, a plurality of finger modules detachably coupled to the palm module, a linear actuator configured to adjust a distance between the plurality of finger modules that are detachably coupled to the palm module, and a plurality of rotation actuators between the linear actuator and the plurality of finger modules, the plurality of rotation actuators configured to respectively rotate the plurality of finger modules about respective first rotation axes extending in a first direction from the palm module toward the plurality of rotation actuators, where the processor may be configured to, based on a first finger module of a first form being coupled to the palm module, receive first module information of the first finger module and control at least one rotation actuator of the plurality of rotation actuators to which the first finger module is coupled and the linear actuator to perform an operation corresponding to the first module information, and based on a second finger module of a second form being coupled to the palm module, receive second module information of the second finger module and control at least one rotation actuator of the plurality of rotation actuators to which the second finger module is coupled and the linear actuator to perform an operation corresponding to the second module information.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a robot apparatus according to one or more embodiments;

FIG. 2 is a diagram illustrating a gripper according to one or more embodiments;

FIG. 3 is a diagram illustrating a gripper according to one or more embodiments;

FIG. 4 is a diagram illustrating a gripper according to one or more embodiments;

FIG. 5 is a diagram illustrating a gripper according to one or more embodiments;

FIG. 6 is a diagram illustrating a gripper according to at least one embodiment of the disclosure;

FIG. 7 is a diagram illustrating a gripper according to one or more embodiments; and

FIG. 8 is a block diagram illustrating a gripper according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

A singular form of a noun corresponding to an item may include one or a plurality of items above, unless otherwise specified in the associated context.

In the disclosure, phrases such as “A or B”, “at least one of A and B”, “at least one of A or B”, “A, B, or C”, “at least one of A, B, and C”, and “at least one of A, B, or C” may respectively include any one or all possible combinations of the items listed together with the relevant phrase of the phrases.

The term “and/or” may include a combination of a plurality of related elements described or any element of the plurality of related elements described.

Terms such as “1st”, “2nd”, or “first” or “second” may be used to simply distinguish a relevant element from another relevant element, and not limit the relevant elements in other aspects (e.g., importance or order).

When a certain (e.g., a first) element is indicated as being “coupled with/to” or “connected to” another (e.g., a second) element, together with or without terms such as “operatively” or “communicatively”, it may be understood as the certain element being coupled with/to the another element directly (e.g., via wire), wirelessly, or through a third element.

It is to be understood that terms such as “have” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “coupled”, “combined”, “supported”, or “contacted” with another element, the above may include not only the elements being directly coupled, combined, supported, or contacted, but also being indirectly coupled, combined, supported, or contacted through the third element.

When the certain element is described as positioned “on” another element, the above may include not only the certain element being contacted to another element, but also other element being present between the two elements.

A plurality of ‘modules’ or a plurality of ‘portions’, except for a ‘module’ or a ‘portion’ which needs to be implemented with a specific hardware, may be integrated in at least one module and implemented as at least one processor.

Operations performed by a module, a program, or another element, in accordance with the various embodiments, may be executed sequentially, in parallel, repetitively, or in a heuristically manner, or at least a portion of the operations may be performed in a different order, omitted, or a different operation may be added.

The various elements and areas of the drawings have been schematically illustrated. Accordingly, the technical spirit of the disclosure is not limited by relative sizes and distances illustrated in the accompanied drawings.

A gripper and a robot apparatus including the gripper according to various embodiments will be described in detail below with reference to the drawings.

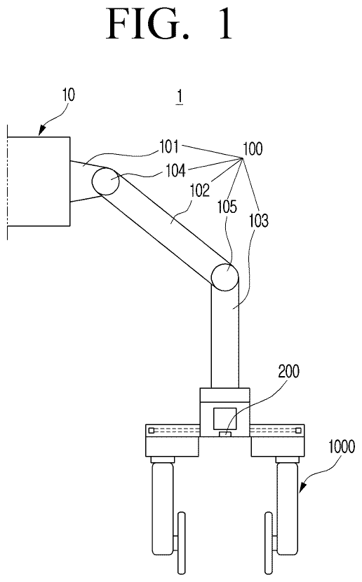

FIG. 1 is a diagram illustrating a robot apparatus 1 according to one or more embodiments.

The robot apparatus 1 may include a main body 10, a robot arm 100, and a gripper 1000.

The main body 10 may be a configuration that includes devices for managing an overall operation of the robot apparatus 1. The main body 10 may be a device that forms an exterior of the robot apparatus 1. In FIG. 1, the main body 10 is shown in a simple quadrangle form, but embodiments are not limited thereto. The robot apparatus 1 may be implemented in various types such as a humanoid robot, a 3-axes core robot, and a 4-legged walking robot, and the main body 10 may be implemented in various forms according to a type of the robot apparatus 1.

For example, the robot apparatus 1 may include various forms such as a body in the case of the humanoid robot, a core module in the case of the 3-axes core robot, and a central module in the case of the 4-legged walking robot. The robot apparatuses 1 of the various types described may include at least one robot arm for performing various operations. Alternatively, the robot apparatus 1 may be implemented as the robot arm itself which is installed within a use environment and can perform various operations.

For convenience of description, FIG. 1 shows the robot apparatus 1 including one robot arm 100 and the gripper 1000, but the type of the robot apparatus 1 and a number and a form of the robot arm may be variously implemented according to the characteristics of the main body 10.

In addition, the main body 10 may be integrally formed with the robot arm 100 and the gripper 1000, or may be formed as separable independent configurations in a form in which each of the independent configurations can be assembled. The main body 10 may be referred to by various terms such as, for example, and without limitation, a housing, a cabinet, a core module, a body part, and the like.

The robot arm 100 may be disposed at one side of the main body 10. The robot arm 100 may include a shoulder base 101, an upper arm 102, a lower arm 130, a first joint 104 connecting the shoulder base 101 to the upper arm 102, and a second joint 105 connecting the upper arm 102 to the lower arm 103. The robot arm 100 may be a configuration that moves the gripper 1000 to a specific position by moving each of the joints 104 and 105. The robot arm 100 may be integrally formed with the main body 10 or may be present as a module independent from the main body 10 and formed in a form assembled onto the main body 10.

The shoulder base 101, the upper arm 102, the lower arm 103 may move variously about each respective axis. The shoulder base 101, the upper arm 102, the lower arm 103 have been all shown as an I-type module in FIG. 1, but embodiments are not limited thereto, and the joints may be formed as modules of various forms such as the L-type module.

The robot arm 100 may include the gripper 1000. The gripper 1000 may be in a form attachable to an end portion of the lower arm 103. Each joint may be connected with each other through a hinge, and each hinge may be included with a motor, a link, and the like for moving each joint.

If the robot arm 100 moves the gripper 1000 to a specific position to perform an operation, the gripper 1000 may perform the operation at the specific position. For example, the gripper 1000 may move to the specific position after grasping a target. In addition, the gripper 1000 may perform various operations such as cleaning, tightening a screw, welding, and the like after grasping the target.

The gripper 1000 may include at least one sensor 200. The robot apparatus 1 may obtain a target or surrounding shape information based on a sensing value of the at least one sensor 200. The robot apparatus 1 may identify a characteristic of the target based on a sensing value of the at least one sensor 200.

The robot apparatus 1 may identify a spatial characteristic of a space in which a target is positioned based on a sensing value of the at least one sensor 200. The spatial characteristic may include information about at least one of a position of the target within the space, a distance between the target and at least one object positioned in a surrounding of the target, and a contact relationship between the target and the surrounding object. In addition, the robot apparatus 1 may identify a characteristic of a grasping point of the target based on a sensing value of the at least one sensor 200.

The characteristic of the grasping point may vary according to an operation of the robot apparatus 1. For example, if the robot apparatus 1 is attempting to lift the target, the characteristic of the grasping point may be a point at which a torque of the target is minimized or near a center of gravity of the target. If the robot apparatus 1 is attempting to rotate the target, the characteristic of the grasping point may be a point farthest from a rotation center of the target. However, embodiments are not limited thereto, and the characteristic of the grasping point may be various points within the target according to a motion of a user.

The robot apparatus 1 may identify various information based on a sensing value of the at least one sensor 200. The at least one sensor 200 may include a vision sensor, an infrared sensor, an ultrasonic sensor, and the like. However, embodiments are not limited thereto, and may include various sensors capable of detecting sensing values for a characteristic of the target, spatial information of the target, the surrounding shape information, information about the grasping point of the target, and the like.

For example, in FIG. 1, the at least one sensor 200 may include an image sensor. The at least one sensor 200 may be formed as various sensors such as a camera or an RGB sensor. The at least one sensor 200 may generate a capture image by using the image sensor.

The robot apparatus 1 may identify the characteristic and the like of the target through a capture image generated from the at least one sensor 200. Specifically, the robot apparatus 1 may extract, after dividing all pixels in the capture image generated from the at least one sensor 200 into a plurality of pixel groups, a pixel representative value of the pixels included in each pixel group.

The robot apparatus 1 may identify a position of a pixel group having a pixel representative value within a similar range from one another, and if a plurality of similar pixel groups is positioned consecutively, identify as the similar pixel groups forming an edge with respect to one object.

The robot apparatus 1 may estimate which object the object is based on a shape of the edge, pixel values of the pixels belonging in the edge, and the like, and identify a distance with the object and the like based on a size of the edge. Based therefrom, the robot apparatus 1 may identify the characteristic and the like of the target.

For example, in FIG. 1, the at least one sensor 200 may include a force and torque sensor (FT sensor). The robot apparatus 1 may measure at least one of a weight and a torque to be added to the gripper 1000 based on a sensing value of the at least one sensor 200. The robot apparatus 1 may identify the center of gravity of the target, the characteristic of the target, and the like based on a sensing value of the at least one sensor 200.

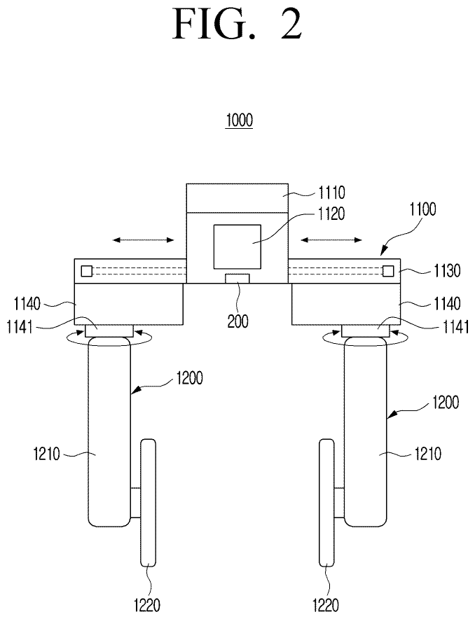

FIG. 2 is a diagram illustrating the gripper 1000 according to one or more embodiments.

In FIG. 2, the gripper 1000 may include a palm module 1100 and a plurality of finger modules 1200.

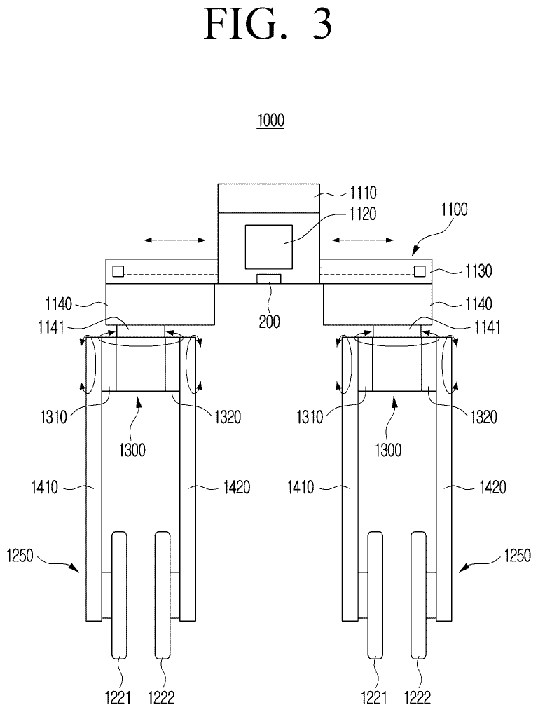

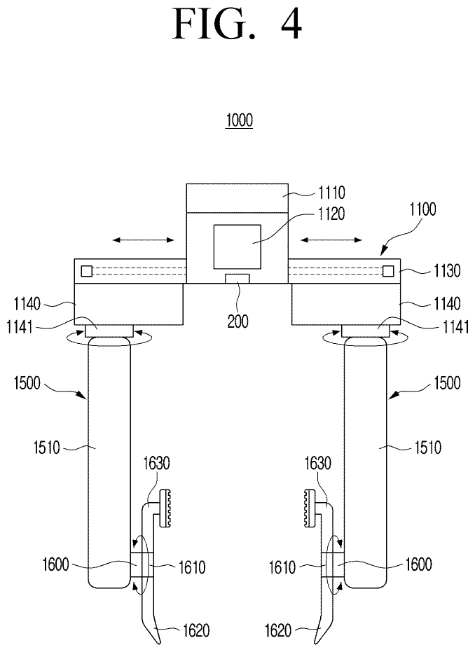

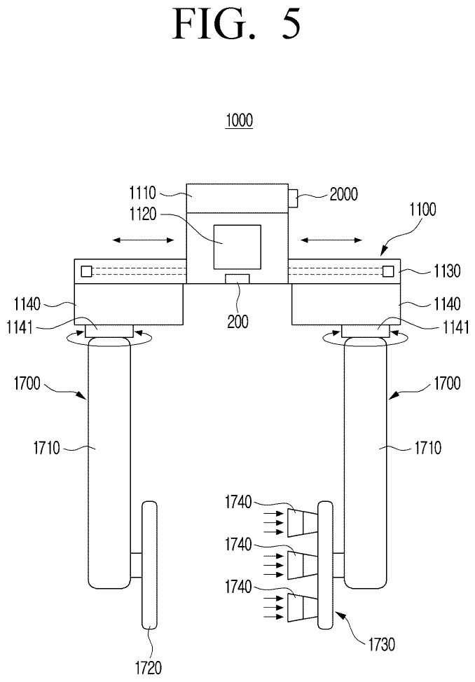

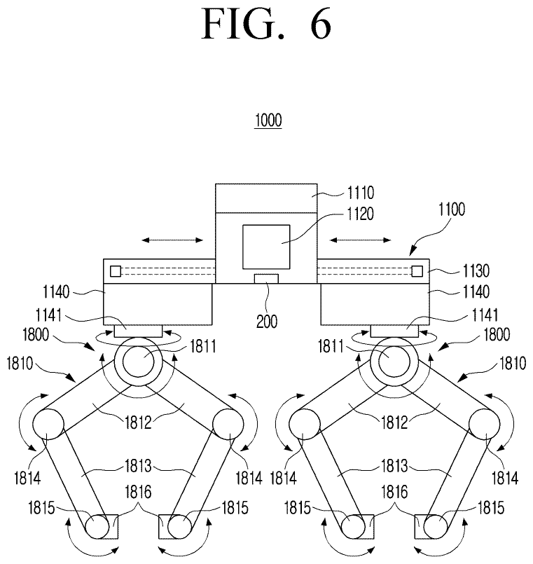

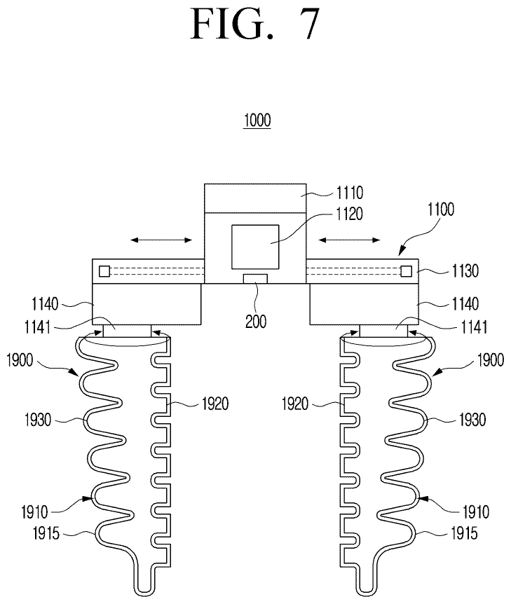

The palm module 1100 may be a module for supporting the plurality of finger modules 1200. The palm module 1100 may be fixedly connected or detachably coupled with the plurality of finger modules 1200 of different forms. The different forms of finger modules 1200 may include the finger modules 1200 of FIG. 2, the finger modules 1250 of FIG. 3, the finger modules 1500 of FIG. 4, the finger modules 1700 of FIG. 5, the finger modules 1800 of FIG. 6, and the finger modules 1900 of FIG. 7. The finger modules 1200, 1300, 1500, 1700, 1800 and 1900 may be detachably coupled to the respective palm modules (e.g., palm module 1100) such that the finger modules provide a modular arrangement with the palm modules. In one or more embodiments, the same finger modules may be detachably coupled to the palm modules. In one or more embodiments, different finger modules of different forms/types may be detachably coupled to the palm module. For example, a palm module 1100 may include finger module 1200 detachably coupled to one rotation actuator, and finger module 1300 detachably coupled to another rotation actuator. Various combinations may be realized as will be understood by one of ordinary skill in the art from the disclosure herein.

The palm module 1100 may include a coupling portion 1110, a linear actuator 1130, and rotation actuators 1140.

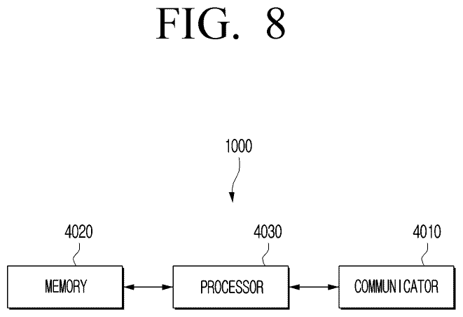

The coupling portion 1110 may be coupled to one end of the robot arm 100 in FIG. 1. Accordingly, the gripper 1000 may be driven integrally with the robot arm 100. Additionally, various electronic components for controlling the gripper 1000 may be included in the coupling portion 1110. For example, the coupling portion 1110 may include a communicator for communicating with various external devices such as the plurality of finger modules 1200, the robot arm 100, and the main body 10, a memory stored with information about the plurality of finger modules 1200 of different forms from one another, a processor for controlling the gripper 1000 and the plurality of finger modules 1200, and the like. The components described above may not necessarily be disposed in the coupling portion 1110, and may be disposed within at least one component within the robot apparatus 1. Detailed descriptions on each of the components will be described in detail in FIG. 8.

The linear actuator 1130 may be a component for adjusting a distance between the plurality of finger modules 1200 coupled to the palm module 1100. The linear actuator 1130 may be disposed at a lower side of the coupling portion 1110. The linear actuator 1130 may include a linear motor 1120. The linear motor 1120 may be disposed at a center of the linear actuator 1130.

The linear actuator 1130 may adjust the distance between the plurality of finger modules 1200 by driving the linear motor 1120.

The linear actuator 1130 may adjust the distance between the plurality of finger modules 1200 through a different driving method from the driving method describe above. The linear actuator 1130 may include a stable release driver (SR driver), an air inlet, and an air outlet.

The SR driver may be a component with which operations of the linear motor 1120 and the gripper 1000 can be controlled. The air inlet may be a component capable of pushing or pulling a piston within the linear actuator 1130 by receiving compressed air from the outside, and the air outlet may be a component capable of pulling or pushing the piston within the linear actuator 1130 by discharging the inside compressed air to the outside.

The linear actuator 1130 may adjust the distance between the plurality of finger modules 1200 by moving the piston through driving of the air inlet and the air outlet.

However, embodiments are not limited to the above-described driving method, and the linear actuator 1130 may adjust the distance between the plurality of finger modules 1200 through various driving methods.

The rotation actuators 1140 may be disposed between the linear actuator 1130 and the plurality of finger modules 1200. The rotation actuators 1140 may rotate each of the plurality of finger modules 1200 based on rotation axes extending in a first direction from the palm module 1100 toward the rotation actuators 1140 (and/or toward the fingers 1210). That is, the first direction may be a direction that extends outwardly from the palm module 1100 toward the direction in which the fingers 1210 extend). For example, with respect to the gripper 1000 in FIG. 2, the first direction may be a length direction of fingers 1210 of the plurality of finger modules 1200.

Each of the plurality of finger modules 1200 may be disposed at one end portions 1141 of the rotation actuators 1140.

In FIG. 2, the plurality of finger modules 1200 may further include the fingers 1210 and fingertips 1220 disposed at end portions of the fingers 1210.

The fingers 1210 may be coupled to the rotation actuators 1140 of the palm module 1100. The fingers 1210 may be formed in an elongated rod form. The length direction of the fingers 1210 may be formed in a direction perpendicular to a length direction of the palm module 1100. However, embodiments are not limited thereto, and the fingers 1210 may be formed into various forms and shapes.

The fingertips 1220 may be disposed at ends of the fingers 1210. The fingertips 1220 may be members capable of physically contacting with a target. If the distance between the plurality of finger modules 1200 is reduced by driving the linear actuator 1130, the fingertips 1220 may grasp the target by being in physical contact with the target.

The finger modules may be implemented in various forms.

Various configurations of the plurality of finger modules 1200 will be described below from FIG. 3.

FIG. 3 is a diagram illustrating the gripper 1000 according to one or more embodiments.

In FIG. 3, the gripper 1000 may include the palm module 1100. The palm module 1100 may include the coupling portion 1110, the linear actuator 1130, and the rotation actuators 1140. A plurality of finger modules 1250 may be detachably coupled to the palm module 1100. The linear actuator 1130 may include the linear motor 1120. Because the descriptions on each of the configurations of the palm module 1100 have been described in detail in FIG. 2, descriptions thereof may be omitted.

Referring to FIG. 3, at least one of the plurality of finger modules 1250 may be disposed at end portions 1141 of the rotation actuators 1140. The at least one of the plurality of finger modules 1250 may further include roll modules 1300 rotatable based on axes in a second direction perpendicular to the rotation axes of the rotation actuators 1140.

The roll modules 1300 may include first rollers 1310 and second rollers 1320 which are disposed at both end portions (e.g., end portions along the second direction, such as the width direction in the view of FIG. 3) and which are independently rotatable.

The first rollers 1310 and the second rollers 1320 may rotate based on the axes in the second direction perpendicular to the rotation axes of the rotation actuators 1140. That is, the first rollers 1310 and the second rollers 1320 may rotate in a clockwise direction or a counterclockwise direction based on the axes in the second direction perpendicular to the first direction.

In addition, the first rollers 1310 and the second rollers 1320 may rotate in a same direction with respect to each other, or rotate in opposite directions from each other. The first rollers 1310 and the second rollers 1320 may rotate freely according to an operation process of the gripper 1000.

Referring to FIG. 3, fingers 1410 and 1420 may be coupled to the first rollers 1310 and the second rollers 1320. That is, the fingers 1410 and 1420 may extend from the roll modules 1300. The fingers 1410 and 1420 may be formed in the elongated rod form. A length direction of the fingers 1410 and 1420 may be formed in a direction perpendicular to the length direction of the palm module 1100. However, embodiments are not limited thereto, and the fingers 1410 and 1420 may be formed into various forms and shapes.

Referring to FIG. 3, fingertips 1221 and 1222 may be attached to each end portion of the fingers 1410 and 1420. Accordingly, the fingers 1410 and 1420 and the fingertips 1221 and 1222 in FIG. 3 may be provided in plurality. Accordingly, the gripper 1000 in FIG. 3 may simultaneously grasp a plurality of targets. In addition, the gripper 1000 in FIG. 3 may simultaneously perform a plurality of operations.

The gripper 1000 may increase a degree of freedom in motion through the rotation actuators 1140 and the roll modules 1300. Accordingly, the gripper 1000 may perform various operations through various methods.

For example, when the gripper 1000 uses only the rotation actuators 1140, each of the plurality of finger modules 1200 may only rotate in the first direction in the clockwise direction or the counterclockwise direction. However, when the gripper 1000 uses the rotation actuators 1140 and the roll modules 1300 together, each of the plurality of finger modules 1200 may rotate in the second direction in the clockwise direction or the counterclockwise direction in addition to rotating in the first direction in the clockwise direction or the counterclockwise direction. Through a rotation combination of the first direction and the second direction, the gripper 1000 may perform various operations.

FIG. 4 is a diagram illustrating the gripper 1000 according to one or more embodiments.

In FIG. 4, the gripper 1000 may include the palm module 1100. The palm module 1100 may include the coupling portion 1110, the linear actuator 1130, and the rotation actuators 1140. A plurality of finger modules 1500 may be detachably coupled to the palm module 1100. The linear actuator 1130 may include the linear motor 1120. Because the descriptions on each of the configurations of the palm module 1100 have been described above, descriptions thereof may be omitted.

In FIG. 4, the gripper 1000 may include finger modules 1500 that include fingers 1510 and fingertips 1610.

The fingers 1510 may be coupled with the rotation actuators 1140 of the palm module 1100. The fingers 1510 may be coupled to the end portions 1141 of the rotation actuators 1140. The fingers 1510 may rotate based on the rotation axes extending in the first direction from the palm module 110 toward the rotation actuators 1140.

The fingertips 1610 may be disposed at end portions of the fingers 1510. The fingertips 1610 may include a plurality of tips 1620 and 1630 of different types from each other which are disposed at positions across each other based on points at which the fingertips are coupled with the fingers 1510. That is, in an axis extending horizontally through the center of rotation tip module 1600 in the view of FIG. 4, the tips 1620 and 1630 may be opposite each other across this axis.

The plurality of tips 1620 and 1630 of different types from each other may include first tips 1620 configured to contact a target and second tips 1630 configured to contact the target. For convenience of description, a portion contactable with the target within the first tips 1620 may be referred to as a first contact surface, and a portion contactable with the target within the second tips 1630 may be referred to as a second contact surface.

A width of the first contact surface and a width of the second contact surface may be implemented differently from each other. In one or more embodiments, the width of the second contact surface of the second tips 1630 may be greater than the width of the first contact surface of the first tips 1620. For example, the length of tip 1630 may be greater than the length of tip 1620 in a cross-sectional view. The second tips 1630 may further include a member in a concave and convex form at a portion that is in physical contact with the target.

In this case, one of the first tips and the second tips may be selectively used according to the characteristic of the target. Specifically, the first tips 1620 may be used for grasping a target with a narrow contact surface, and the second tips 1630 may be used for grasping a target with a wider contact surface than the target that the first tips 1620 can grasp.

The plurality of finger modules 1200 may include rotation tip modules 1600 for rotating the fingertips 1610 for a tip corresponding to the characteristic of the target of the plurality of tips 1620 and 1630 to face the target.

The plurality of finger modules 1200 may rotate the plurality of tips 1620 and 1630 in the clockwise direction or the counterclockwise direction based on the rotation tip modules 1600.

Accordingly, the gripper 1000 may grasp targets having various shapes and sizes stably.

FIG. 5 is a diagram illustrating the gripper 1000 according to one or more embodiments.

In FIG. 5, the gripper 1000 may include the palm module 1100. The palm module 1100 may include the coupling portion 1110, the linear actuator 1130, and the rotation actuators 1140. Finger modules 1700 may be detachably coupled to the palm module 1100. The linear actuator 1130 may include the linear motor 1120. Because the descriptions on each of the configurations of the palm module 1100 have been described above, descriptions thereof may be omitted.

In FIG. 5, the gripper 1000 may include finger modules 1700 that include fingers 1710 and fingertips 1720 and 1730.

The fingers 1710 may be coupled with the rotation actuators 1140 of the palm module 1100. The fingers 1710 may be coupled to the end portions 1141 of the rotation actuators 1140. The fingers 1710 may rotate based on the rotation axes extending in the first direction from the palm module 1100 toward the rotation actuators 1140.

The fingertips 1720 and 1730 may be disposed at end portions of the fingers 1710. A first tip 1720 of the fingertips 1720 and 1730 may be a component for supporting a target. A second tip 1730 of the fingertips 1720 and 1730 may be a component for grasping the target using suction force.

The second tip 1730 may include at least one suction tip 1740. The coupling portion 1110 may include a suction power port 2000. The at least one suction tip 1740 of the second tip 1730 may suction the target using power and pressure supplied from the suction power port 2000. That is, the at least one suction tip 1740 may grasp the target through vacuum adsorption.

Through the above, the fingertips 1720 and 1730 may grasp the target, and perform various operations using the target.

FIG. 6 is a diagram illustrating the gripper 1000 according to one or more embodiments.

In FIG. 6, the gripper 1000 may include the palm module 1100. The palm module 1100 may include the coupling portion 1110, the linear actuator 1130, and the rotation actuators 1140. Finger modules 1800 may be detachably coupled to the palm module 1100. The linear actuator 1130 may include the linear motor 1120. Because the descriptions on each of the configurations of the palm module 1100 have been described above, descriptions thereof may be omitted.

In FIG. 6, each of the plurality of finger modules 1800 may include dual pinchers 1810.

The dual pinchers 1810 may grasp a target using a plurality of fingertips. The dual pinchers 1810 may include a plurality of finger phalanges 1812 and 1813, a plurality of finger joints 1811, 1814, and 1815, and a plurality of fingertips 1816.

The plurality of finger phalanges 1812 and 1813 may include first finger phalanges 1812 and second finger phalanges 1813.

The plurality of finger joints 1811, 1814, and 1815 may include first finger joints 1811, second finger joints 1814, and third finger joints 1815. The plurality of finger joints 1811, 1814, and 1815 may be disposed between the plurality of finger phalanges 1812 and 1813 or the plurality of fingertips 1816. Due to the plurality of finger joints 1811, 1814, and 1815 being disposed, the dual pinchers 1810 may grasp targets having various shapes and sizes. For example, if the size of the target is large, the robot apparatus 1 may control the plurality of finger joints 1811, 1814, and 1815 to widen the distance between the plurality of finger phalanges 1812 and 1813.

Alternatively, if the size of the target is small, the robot apparatus 1 may control the plurality of finger joints 1811, 1814, and 1815 to narrow the distance between the plurality of finger phalanges 1812 and 1813.

The plurality of fingertips 1816 may be disposed at the third finger joints 1815. The plurality of fingertips 1816 may be physically contacted with the target.

In addition, the robot apparatus 1 may control the plurality of finger joints 1811, 1814, and 1815, and lift the grasped target from a lower side to an upper side direction.

FIG. 7 is a diagram illustrating the gripper 1000 according to one or more.

In FIG. 7, the gripper 1000 may include the palm module 1100. The palm module 1100 may include the coupling portion 1110, the linear actuator 1130, and the rotation actuators 1140. Finger modules 1900 may be detachably coupled to the palm module 1100. The linear actuator 1130 may include the linear motor 1120. Because the descriptions on each of the configurations of the palm module 1100 have been described above, descriptions thereof may be omitted.

In FIG. 7, each of the plurality of finger modules 1900 may include soft jaws 1910. The soft jaws 1910 may include a plurality of concave and convex portions 1920 at one side thereof. The soft jaws 1910 may include a plurality of bent portions 1930 at an opposite side of the plurality of concave and convex portions 1920. The plurality of concave and convex portions 1920 and the plurality of bent portions 1930 may respectively grasp targets of different sizes from one another.

The soft jaws 1910 may include an elastic element 1915 at an outer surface thereof to prevent damage to the target in the process of grasping the target. That is, each of the plurality of finger modules 1200 may include the elastic element 1915 at the outer surface thereof.

Each of the plurality of finger modules 1200 may be formed with various materials such as, for example, and without limitation, rubber, silicon, polyurethane, ethylene propylene diene monomer (EPDM), and the like.

FIG. 8 is a block diagram illustrating the gripper 1000 according to one or more embodiments.

In FIG. 8, the gripper 1000 may include a communicator 4010, a memory 4020, and a processor 4030. However, in FIG. 8, although the configuration of the communicator 4010, the memory 4020, and the processor 4030 has been described as included in the gripper 1000, embodiments are not limited thereto, and the components may be included in the main body 10 of the robot apparatus 1. In addition, the communicator 4010, the memory 4020, and the processor 4030 may be included independently in the robot apparatus 1 and the gripper 1000, respectively. In addition, in FIG. 8, one of the communicator 4010, the memory 4020, and the processor 4030 have been respectively shown, but each configuration may not necessarily be provided singularly and may be provided in plurality. In addition, the memory 4020 and the processor 4030 may be integrated as a single chip.

The communicator 4010 may be a component for performing communication with various different devices. Specifically, the communicator 4010 may perform communication with various devices such as, for example, and without limitation, the plurality of finger modules 1200, the main body 10 of the robot apparatus 1, the robot arm 100 of the robot apparatus 1, and the like.

The communicator 4010 may include at least one wireless communication module, at least one wired communication module, and the like. Each communication module may be implemented as at least one hardware chip form. The wireless communication module may include at least one module of a Wi-Fi module, a Bluetooth module, an infrared communication module, or other communication modules. In addition thereto, the communicator 4010 may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like. The wired communication module may include at least one of, for example, a Local Area Network (LAN) module, an Ethernet module, a pair cable, a coaxial cable, an optical fiber cable, or an Ultra Wide-Band (UWB) module.

In FIG. 8, the communicator 4010 may include a Controller Area Network (CAN) communicator. The CAN communicator of the gripper 1000 may communicate with various control devices (e.g., the main body 10, the robot arm 100, and the plurality of finger modules). Through the above, the gripper 1000 may detect and correct data transmission errors while communicating with various control devices.

The memory 4020 may be a component for containing various programs, instructions, data, and the like necessary in an operation of the gripper 1000. In FIG. 8, the memory 4020 has been shown as separate from the processor 4030, but embodiments are not limited thereto, and the memory 4020 may be implemented as an internal memory such as a read only memory (ROM) (e.g., an electrically erasable programmable read-only memory (EEPROM)), a random access memory (RAM), and the like included in the processor 4030.

Alternatively, the memory 4020 may be implemented in a form of a memory embedded in the gripper 1000 according to data storage use, or implemented in a form of a memory attachable to or detachable from the gripper 1000. Specifically, the memory 4020 of the gripper 1000 may be implemented in various forms such as, for example, and without limitation, a volatile memory (e.g., a static RAM (SRAM) or a synchronous dynamic RAM (SDRAM), etc.), a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory, a hard disk drive (HDD), or a solid state drive (SSD)), a compact flash (CF), a secure digital (SD), a micro secure digital (MicroSD), a mini secure digital (Mini-SD), an extreme digital (xD), a multi-media card (MMC), and the like.

The term memory may include a storage portion, a ROM in the processor 4030, a RAM, a memory card mounted to the electronic device (e.g., a micro SD card, a memory stick), etc.

The memory 4020 may be accessed by the processor 4030. In the memory 4020, reading, writing, modifying, deleting, updating, and the like of data may be performed by the processor 4030.

Specifically, in the memory 4020, various information such as, for example, and without limitation, information about the palm module 1100, information about the linear actuator 1130, information about the rotation actuators 1140, information about the plurality of finger modules 1200, 1250, 1500, 1700, 1800, 1900, information about the roll modules 1300, operation information about the roll modules 1300, information about the plurality of tips 1620 and 1630 of different types from one another, information about the rotation tip modules 1600, information about the at least one suction tip 1740, information about the dual pinchers 1810, information about the soft jaws 1910, information about the at least one sensor 200, and the like, and programs, instructions, and the like for controlling operations of the gripper 1000 and other devices may be stored.

The processor 4030 may be a component for controlling the overall operation of the gripper 1000 by being connected with each component of the gripper 1000. The processor 4030 may be implemented as a digital signal processor (DSP) for processing a digital image signal, a microprocessor, a graphics processing unit (GPU), and the like. However, embodiments are not limited thereto, and the processor 4030 may include one or more of a central processing unit (CPU), a micro controller unit (MCU), a micro processing unit (MPU), a controller, an application processor (AP), a communication processor (CP), or an ARM processor, or may be defined by a relevant term. In addition, the processor 4030 may be implemented as a System on Chip (SoC) or a large scale integration (LSI) in which a processing algorithm is embedded, and may be implemented in a form of an application specific integrated circuit (ASIC) and a field programmable gate array (FPGA).

The processor 4030 may perform at least one of the above-described various operations based on an artificial intelligence model. The processor 4030 for executing the artificial intelligence model may implemented through a combination of software with a generic-purpose processor such as the CPU, the AP, and the DSP, a graphics dedicated processor such as the GPU and a vision processing unit (VPU), or an artificial intelligence dedicated processor such as a neural processing unit (NPU).

If the processor 4030 is implemented as the artificial intelligence dedicated processor, the processor may be designed as a hardware chip, or the like such as the ASIC or the FPGA specialized in processing of a specific artificial intelligence model.

If the processor 4030 is implemented as a dedicated processor, the processor may be implemented to include the memory 4020 for implementing an embodiment of the disclosure, or implemented to include a memory processing function for using an external memory. The processor 4030 may be implemented singularly or in plurality. In addition, the processor 4030 may perform various operations based on programs, instructions, data, and the like stored in the memory 4020.

The configurations of the processor 4030 of the gripper 1000 described above may be included in not only the processor 4030 of the gripper 1000, but also in a processor of the robot apparatus 1.

Various information received in the gripper 1000 and information generated from the gripper 1000, for example, information about the coupled plurality of finger modules 1200, information about the coupled robot arm 100, information about the palm module 1100, information about the linear actuator 1130, information about the rotation actuators 1140, information about the plurality of finger modules 1200, information about the roll modules 1300, operation information about the roll modules 1300, information about the plurality of tips 1620 and 1630 of different types from one another, information about the rotation tip modules 1600, information about the at least one suction tip 1740, information about the dual pinchers 1810, information about the soft jaws 1910, information about the at least one sensor 200, and the like may be stored in the memory 4020.

The processor 4030 may control the linear actuator 1130 to adjust the distance between the plurality of finger modules 1200. Accordingly, the gripper 1000 may grasp the target and the like using the plurality of finger modules 1200.

The processor 4030 may control the rotation actuators 1140 to rotate each of the plurality of finger modules 1200 based on the rotation axes extending in the first direction from the palm module 1100 toward the rotation actuators. By rotating each of the plurality of finger modules 1200 about the axes in the first direction in the clockwise direction or the counterclockwise direction, not only operations involving grasping, but also various operations such as screw coupling, welding, and the like may be performed.

The processor 4030 may store, based on at least one finger module of the plurality of finger modules 1200 being coupled to the palm module 1100, module information of the at least one finger module in the memory 4020 by receiving through the communicator 4010. As described above, the communicator 4010 may perform communication with the finger modules 1200 through various wired and wireless interfaces. The module information may include various information associated with a relevant finger module. For example, the module information may include information and the like on a type of the finger module, a product number, manufacturing company information, a product specification, and an operation performable by the finger module. The processor 4030 may identify, based on the received module information, whether or not which finger module is in a coupled state, description on an operation performable by the same finger module, and the like.

The processor 4030 may control at least one of the rotation actuators 1140 and the linear actuator 1130 when at least one finger module is coupled to perform the operation corresponding to the module information.

For example, when the roll modules 1300 of the plurality of finger modules 1200 are coupled, the processor 4030 may store information about the roll modules 1300 in the memory 4020 by receiving through the communicator 4010. Then, the processor 4030 may control at least one of the rotation actuators 1140 and the linear actuator 1130 to perform an operation corresponding to the roll modules 1300.

In addition, the processor 4030 may control the roll modules 1300 based on information about the roll modules 1300 pre-stored in the memory 4020. For example, the processor 4030 may control the roll modules 1300 to rotate the first rollers 1310 and the second rollers 1320 based on rotation information of the first rollers 1310 and the second rollers 1320 of the roll modules 1300 stored in the memory 4020. Specifically, the processor 4030 may control the roll modules 1300 to rotate the fingers based on the axes in the second direction perpendicular to the first direction. The processor 4030 may control the roll modules 1300 to rotate the first rollers 1310 and the second rollers 1320 in the same direction or in opposite directions based on the axes in the second direction.

Accordingly, the gripper 1000 may increase the degree of freedom in motion through the rotation actuators 1140 and the roll modules 1300. Accordingly, the gripper 1000 may perform various operations through various methods.

The processor 4030 may store, when a finger module coupled to the palm module 110 is substituted, module information of the substituted finger module in the memory 4020 by receiving through the communicator 4010. The processor 4030 may control each of the linear actuator 1130 and the rotation actuators 1140 to perform an operation corresponding to the module information of the substituted finger module.

For example, when substituted to finger modules that include the plurality of tips 1620 and 1630 different from each other in the roll modules 1300, the processor 4030 may receive module information of the finger modules that include the plurality of tips 1620 and 1630 different from each other through the communicator 4010 and store the same in the memory 4020. Then, the processor 4030 may control each of the linear actuator 1130 and the rotation actuators 1140 to perform an operation corresponding to the module information of the substituted finger modules that include the plurality of tips 1620 and 1630 different from each other. In other words, first finger modules may be detachably coupled to the gripper, and the processor 4030 may receive first module information for controlling the first finger modules, and then the first finger modules may be detached from the gripper and second finger modules that are of a different form/type from the first finger modules may be detachably coupled to the gripper. Thus, the processor 4030 may receive second module information for controlling the second finger modules.

In addition, the processor 4030 may control the rotation tip modules 1600 for a fingertip of a type corresponding to the identified characteristic of the plurality of tips 1620 and 1630 to face a target.

Specifically, the processor 4030 may control the plurality of finger modules 1200 to grasp the target using the first tips 1620 if the size of the target is less than a pre-set size range, and grasp the target using the second tips 1630 if the size of the target is greater than or equal to the pre-set size range.

The pre-set size range may be a maximum size of the target that is graspable by the first tips 1620.

When the finger module including the suction tips 1740 is coupled to the palm module 1100, the processor 4030 may control the suction tips 1740 to grasp the target through an operation of adsorption.

When the dual pinchers 1810 are coupled to the palm module 1100, the processor 4030 may control the plurality of finger joints 1811, 1814, and 1815 to grasp the target through the plurality of fingertips 1816.

As described above, the processor 4030 may perform various operations by controlling a movement of the gripper according to the various finger modules coupled to the gripper 1000.

Each of the elements described in the disclosure may be configured with one or more components, and designations of the relevant elements may vary according to the gripper 1000 and the type of the robot apparatus 1 that includes the gripper 1000.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A gripper, comprising:
a palm module configured such that finger modules of different forms are detachably couplable to the palm module;
a plurality of finger modules detachably coupled to the palm module;
a linear actuator configured to adjust a distance between the plurality of finger modules that are detachably coupled to the palm module; and
a plurality of rotation actuators between the linear actuator and the plurality of finger modules, the plurality of rotation actuators configured to respectively rotate the plurality of finger modules about respective first rotation axes extending in a first direction from the palm module toward the plurality of rotation actuators.

2. The gripper of claim 1, wherein at least one finger module of the plurality of finger modules further comprises:
a roll module that is rotatable about a second axis extending in a second direction that is perpendicular to a respective first rotation axis; and
at least one finger extending from the roll module.

3. The gripper of claim 2, wherein the roll module comprises:
a first roller and a second roller on opposite ends of the roll module in the second direction, and that are independently rotatable, and
wherein the first roller is rotatable in a direction that is opposite to a direction in which the second roller is rotatable.

4. The gripper of claim 1, wherein each finger module of the plurality of finger modules further comprises:
a finger detachably couplable to a respective rotation actuator of the plurality of rotation actuators; and
a plurality of fingertips at an end portion of the finger.

5. The gripper of claim 4, wherein each fingertip of the plurality of fingertips comprise:
a plurality of tips of different types from one another which are across each other based on a point where a respective fingertip is coupled to a respective finger module of the plurality of finger modules, and
wherein each finger module of the plurality of finger modules further comprises a rotation tip module configured to rotate a respective fingertip to cause a tip corresponding to a characteristic of a target to face the target.

6. The gripper of claim 5, wherein the plurality of tips comprise:
a first tip having a first contact surface configured to contact the target; and
a second tip having a second contact surface configured to contact the target, and
wherein a width of the second contact surface is greater than a width of the first contact surface.

7. The gripper of claim 4, wherein the plurality of fingertips further comprise:
suction tips configured to grasp a target.

8. The gripper of claim 1, further comprising:
a memory;
a communicator; and
a processor configured to:
store, based on at least one finger module of the plurality of finger modules being coupled to the palm module, first module information of the at least one finger module in the memory based on receiving the first module information through the communicator, and
control at least one rotation actuator of the plurality of rotation actuators to which the at least one finger module is coupled and the linear actuator to perform an operation corresponding to the first module information.

9. The gripper of claim 8, wherein the processor is further configured to:
store, based on a first finger module that is coupled to the palm module being substituted with a second finger module, second module information of the second finger module in the memory based on receiving the second module information through the communicator, and
control the linear actuator and the at least one rotation actuator to perform an operation corresponding to the second module information of the substituted finger module.

10. The gripper of claim 1, wherein each finger module of the plurality of finger modules further comprises:
dual pinchers coupled to a respective rotation actuator of the plurality of rotation actuators and configured to grasp a target.

11. The gripper of claim 1, wherein each finger module of the plurality of finger modules further comprises:
an elastic element at an outer surface of the figure module configured to prevent damage to a target in a process of grasping the target.

12. A robot apparatus, comprising:
a main body; and
a gripper coupled to the main body,
wherein the gripper comprises:
a palm module configured such that finger modules of different forms are detachably couplable to the palm module;
a plurality of finger modules detachably coupled to the palm module;
a linear actuator configured to adjust a distance between the plurality of finger modules that are detachably coupled to the palm module; and
a plurality of rotation actuators between the linear actuator and the plurality of finger modules, of the plurality of rotation actuators configured to respectively rotate the plurality of finger modules about respective first rotation axes extending in a first direction from the palm module toward the plurality of rotation actuators.

13. The robot apparatus of claim 12, wherein at least one finger module of the plurality of finger modules further comprises:
a roll module that is rotatable about a second axis extending in a second direction that is perpendicular to a respective first rotation axis; and
at least one finger extending from the roll module.

14. The robot apparatus of claim 13, wherein the roll module comprises:
a first roller and a second roller on opposite ends of the roll module in the second direction, and that are independently rotatable, and
wherein the first roller is rotatable in a direction that is opposite to a direction in which the second roller is rotatable.

15. The robot apparatus of claim 12, wherein each finger module of the plurality of finger modules further comprises:
a finger detachably couplable to a respective rotation actuator of the plurality of rotation actuators; and
a plurality of fingertips at an end portion of the finger.

16. The robot apparatus of claim 15, wherein each fingertip of the plurality of fingertips comprise:
a plurality of tips of different types from one another which are across each other based on a point where a respective fingertip is coupled to a respective finger module of the plurality of finger modules, and
wherein each finger module of the plurality of finger modules further comprises a rotation tip module configured to rotate a respective fingertip to cause a tip corresponding to a characteristic of a target to face the target.

17. The robot apparatus of claim 16, wherein the plurality of tips comprise:
a first tip having a first contact surface configured to contact the target; and
a second tip having a second contact surface configured to contact the target, and
wherein a width of the second contact surface is greater than a width of the first contact surface.

18. The robot apparatus of claim 12, further comprising:
a memory;
a communicator; and
a processor configured to:
store, based on at least one finger module of the plurality of finger modules being coupled to the palm module, first module information of the at least one finger module in the memory based on receiving the first module information through the communicator, and
control at least one rotation actuator of the plurality of rotation actuators to which the at least one finger module is coupled and the linear actuator to perform an operation corresponding to the first module information.

19. The robot apparatus of claim 18, wherein the processor is further configured to:
store, based on a first finger module that is coupled to the palm module being substituted with a second finger module, second module information of the second finger module in the memory based on receiving the second module information through the communicator, and
control the linear actuator and the at least one rotation actuator to perform an operation corresponding to the second module information of the substituted finger module.

20. A gripper, comprising:
a processor,
a palm module configured such that finger modules of different forms are detachably couplable to the palm module;
a plurality of finger modules detachably coupled to the palm module;
a linear actuator configured to adjust a distance between the plurality of finger modules that are detachably coupled to the palm module; and
a plurality of rotation actuators between the linear actuator and the plurality of finger modules, the plurality of rotation actuators configured to respectively rotate the plurality of finger modules about respective first rotation axes extending in a first direction from the palm module toward the plurality of rotation actuators,
wherein the processor is configured to:
based on a first finger module of a first form being coupled to the palm module, receive first module information of the first finger module and control at least one rotation actuator of the plurality of rotation actuators to which the first finger module is coupled and the linear actuator to perform an operation corresponding to the first module information, and
based on a second finger module of a second form being coupled to the palm module, receive second module information of the second finger module and control at least one rotation actuator of the plurality of rotation actuators to which the second finger module is coupled and the linear actuator to perform an operation corresponding to the second module information.
